(19) United States
(12) Patent Application Publication
(10) Pub. No.: US 2021/0053690 A1
(43) Pub. Date: Feb. 25, 2021

(54) VEHICLE RECOVERY SYSTEM

(71) Applicant: AVIATION SAFETY RESOURCES, INC., STANFORD, KY (US)

(72) Inventors: LARRY EDWARD WILLIAMS, Danville, KY (US); ROBERT LAFRANCE, Apache Junction, AZ (US); GEORGE GALLOWAY, Dunlap, TN (US)

(73) Assignee: AVIATION SAFETY RESOURCES, INC., STANFORD, KY (US)

(21) Appl. No.: 16/545,457

(22) Filed: Aug. 20, 2019

(51) Int. Cl. B64D 17/80; B64D 17/14; B64D 17/30; B64D 17/24; B64D 17/72

(52) U.S. Cl. CPC B64D 17/80; B64D 17/14; B64D 17/725; B64D 17/24; B64D 17/30

(57) ABSTRACT

A vehicle recovery system includes a harness having a hub and a plurality of cords each including opposite first and second ends. The first ends are each coupled to the hub. The second ends are each configured to be connected to a fuselage of a vehicle. A tractor rocket includes a body and a bridle. The bridle includes a first end coupled to the body and an opposite second end. A parachute includes a riser, a canopy and a plurality of suspension lines. The suspension lines each include a first end coupled the canopy and an opposite second end coupled a first end of the riser. An opposite second end of the riser is coupled to the hub. The second end of the bridle is coupled to the first end of the riser.

### TECHNICAL FIELD

The present disclosure relates, in general, to the field of aviation. More specifically, it relates to a system that enables the safe landing of an aircraft or Urban Air Mobility (UAM) vehicle in case of an in-flight emergency.

### BACKGROUND

In the eventuality of an in-flight emergency, an aircraft/UAM vehicle may be required to perform emergency landing procedures. In order to facilitate safe emergency landing procedures, the aircraft/UAM vehicle is equipped with various aircraft/UAM vehicle safety systems. These aircraft/UAM vehicle safety systems may deploy safety devices, such as parachutes, drogue chutes, rocket members, and airbags. For example, the parachutes help to reduce the downward speed of the fall of the aircraft/UAM vehicle during the in-flight emergency. The drogue chutes help in reducing the forward speed of the aircraft/UAM vehicle. The rocket members may be used for reducing the downward speed of the fall of the aircraft/UAM vehicle, the forward speed of the aircraft/UAM vehicle, or both, depending on their alignment with the aircraft/UAM vehicle. The airbags help in reducing the impact of the aircraft/UAM vehicle on landing.

However, there remains several problem areas inherent with conventional whole airframe parachute systems. In particular, the time to extract and inflate one large canopy with conventional whole airframe parachute systems is too long resulting in excessive altitude loss limiting the effectiveness in a vertical take-off or landing environment. Traditionally, whole airframe recovery system designers have concentrated primarily on the problem of a typical “in-flight” operational envelop with forward speed and altitude. Both factors are significantly modified (no forward speed) in a Vertical Take-Off and Landing (VTOL) and electric VTOL (eVTOL) aircraft/UAM vehicle envelope. That is, conventional whole airframe recovery systems are not adapted for low speed, low altitude deployment. Indeed, most current recovery systems on the market today, when deployed at very low speeds and altitudes, lack the capability of saving lives unless the aircraft/UAM vehicle has significant altitude. This means that the emergency deployment at low speed and low altitude, with traditional recovery systems, will “ride it in” hoping to survive the crash. There simply is not enough time to extract the parachute, fill the canopy and retard the decent to a survivable rate in the time available prior to impact with the ground. This disclosure describes an improvement over these prior art technologies.

### SUMMARY

In one embodiment, in accordance with the principles of the present disclosure, a vehicle recovery system comprises a harness having a hub and a plurality of cords each including opposite first and second ends. The first ends are each coupled to the hub. The second ends are each configured to be connected to a fuselage of a vehicle. A tractor rocket includes a body and a bridle. The bridle includes a first end coupled to the body and an opposite second end. A parachute includes a riser, a canopy and a plurality of suspension lines. The suspension lines each include a first end coupled the canopy and an opposite second end coupled a first end of the riser. An opposite second end of the riser is coupled to the hub. The second end of the bridle is coupled to the first end of the riser.

In one embodiment, in accordance with the principles of the present disclosure, a vehicle recovery system comprises a harness comprising a hub and a plurality of cords each including opposite first and second ends. The first ends are each coupled to the hub. The second ends are each configured to be connected to a fuselage of a vehicle. A retro-rocket includes a first body and a first bridle. The first bridle includes a first end coupled to the first body and an opposite second end coupled to the hub. A plurality of tractor rockets each include a second body and a second bridle. The second bridle includes a first end coupled to the second body and an opposite second end. A plurality of parachutes each include a riser, a canopy and a plurality of suspension lines. The suspension lines each include a first end coupled the canopy and an opposite second end coupled to a first end of the riser. An opposite second end of the riser is coupled to the hub. The second end of the second bridle is coupled to the first end of the riser.

In one embodiment, in accordance with the principles of the present disclosure, a method for recovering a vehicle is provided that comprises providing a vehicle having a fuselage equipped with a vehicle recovery system. The vehicle recovery system comprises a harness comprising a hub and a plurality of cords each including opposite first and second ends. The first ends are each coupled to the hub. The second ends are each configured to be connected to the fuselage. A retro-rocket includes a first body and a first bridle. The first bridle includes a first end coupled to the first body and an opposite second end coupled to the hub. A plurality of tractor rockets each include a second body and a second bridle. The second bridle includes a first end coupled to the second body and an opposite second end. A plurality of parachutes each include a riser, a canopy and a plurality of suspension lines. The suspension lines each include a first end coupled the canopy and an opposite second end coupled to a first end of the riser. An opposite second end of the riser is coupled to the hub. The second end of the bridle is coupled to the first end of the riser. The retro-rocket is deployed to reduce a downward speed of the vehicle. The tractor rockets are deployed after the retro-rocket is deployed such that the canopies each move from a concave orientation to a convex orientation as the parachutes descend to further reduce the downward speed of the vehicle.

### BRIEF DESCRIPTION OF THE DRAWINGS

The present disclosure will become more readily apparent from the specific description accompanied by the following drawings, in which:

FIG. 1 is a graph showing the minimum deployment altitude for various vehicle recovery systems (combinations of size of the retro rock and specific parachutes) to produce a touchdown condition that is survivable and will allow occupants of the aircraft/vehicle to self-extricate;

FIG. 2 is a side, breakaway view of one embodiment of a vehicle recovery system, in accordance with the principles of the present disclosure;

FIG. 3 is a side, breakaway view of components of the vehicle recovery system shown in FIG. 2;

FIG. 3A is a side view of components of the vehicle recovery system shown in FIG. 2;

FIG. 4 is a side, breakaway view of components of the vehicle recovery system shown in FIG. 2;

FIG. 4A is a side, breakaway view of components of the vehicle recovery system shown in FIG. 2;

FIG. 5 is a chart showing the descent rate of a vehicle equipped with the vehicle recovery system shown in FIG. 2;

FIG. 6 is a close up, perspective view of components of the vehicle recovery system shown in FIG. 2;

FIG. 7 is a perspective, breakaway view of components of the vehicle recovery system shown in FIG. 2;

FIG. 8 is an enlarged, perspective view of components of the vehicle recovery system shown in Detail A of FIG. 7;

FIG. 9 is a perspective, breakaway view of components of the vehicle recovery system shown in FIG. 2;

FIG. 10 is an enlarged, breakaway, cross-sectional view of components of the vehicle recovery system shown in Detail B of FIG. 9;

FIG. 11 is a breakaway, cross-sectional view of components of the vehicle recovery system shown in FIG. 2 taken along lines C-C of FIG. 10;

FIG. 12 is a breakaway, cross-sectional view of components of the vehicle recovery system shown in FIG. 2 taken along lines D-D of FIG. 10;

FIG. 13 is a breakaway, cross-sectional view of components of the vehicle recovery system shown in FIG. 2 taken along lines E-E of FIG. 10;

FIG. 14 is an enlarged, breakaway, cross-sectional view of components of the vehicle recovery system shown in Detail F of FIG. 11;

FIG. 15 is a perspective, breakaway view of components of the vehicle recovery system shown in FIG. 2;

FIG. 16 is a perspective, breakaway view of components of the vehicle recovery system shown in FIG. 2;

FIG. 17 is a top view of components of one embodiment of the vehicle recovery system shown in FIG. 2, in accordance with the principles of the present disclosure;

FIG. 17A is a top view of components of one embodiment of the vehicle recovery system shown in FIG. 2, in accordance with the principles of the present disclosure;

FIG. 18 is a perspective view of components of the vehicle recovery system shown in FIG. 2;

FIG. 19 is a perspective view of components of the vehicle recovery system shown in FIG. 2;

FIG. 20A is a side view, in part cross-section, of components of the vehicle recovery system shown in FIG. 2;

FIG. 20B is a top view of components of the vehicle recovery system shown in FIG. 2;

FIG. 21 is a perspective view of components of the vehicle recovery system shown in FIG. 2;

FIG. 22A is a perspective view of components of the vehicle recovery system shown in FIG. 2;

FIG. 22B is a perspective view of components of the vehicle recovery system shown in FIG. 2;

FIG. 23A is a perspective view of components of the vehicle recovery system shown in FIG. 2; and

FIG. 23B is a perspective view of components of the vehicle recovery system shown in FIG. 2.

Like reference numerals indicate similar parts throughout the figures.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

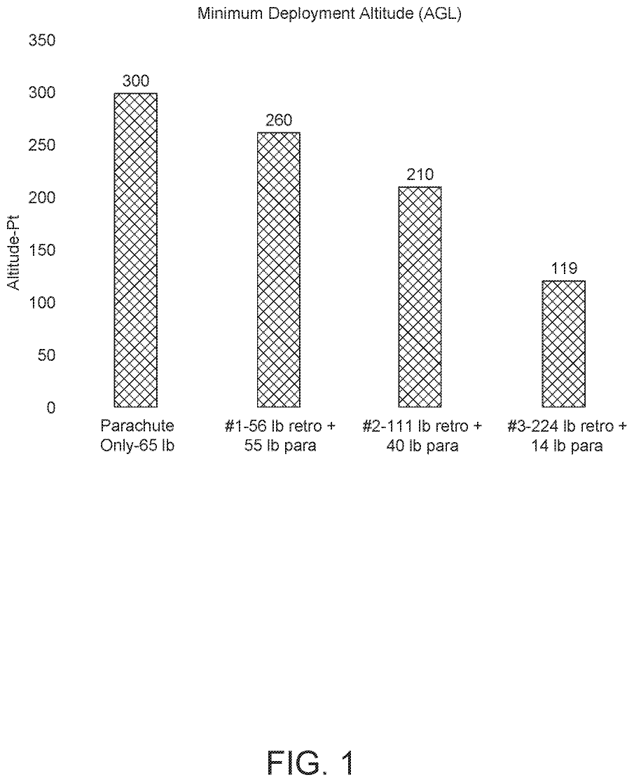

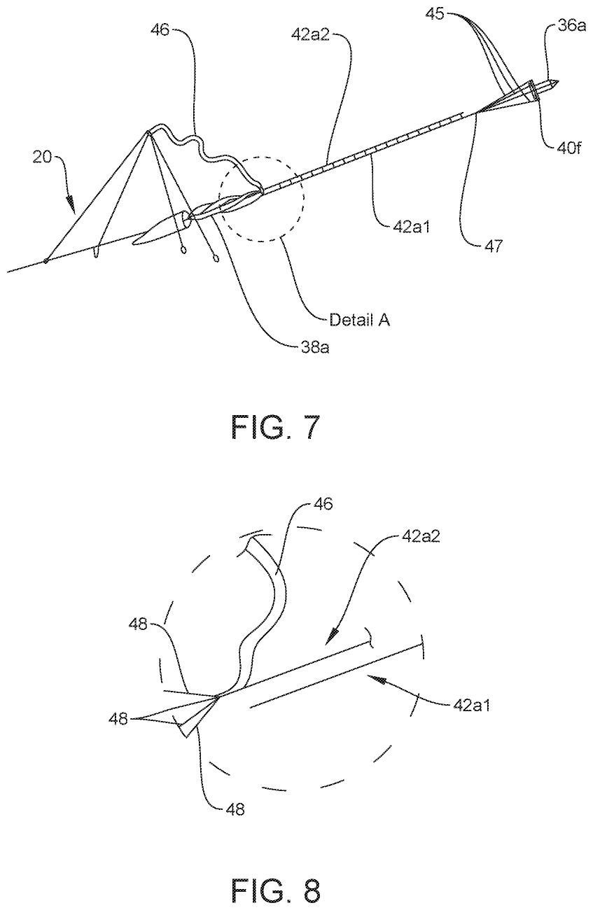

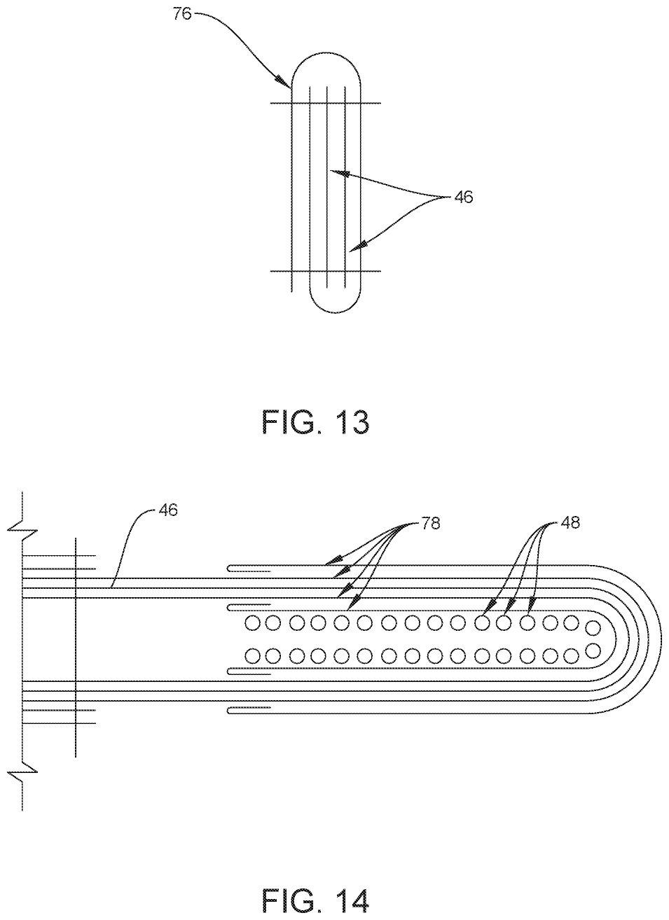

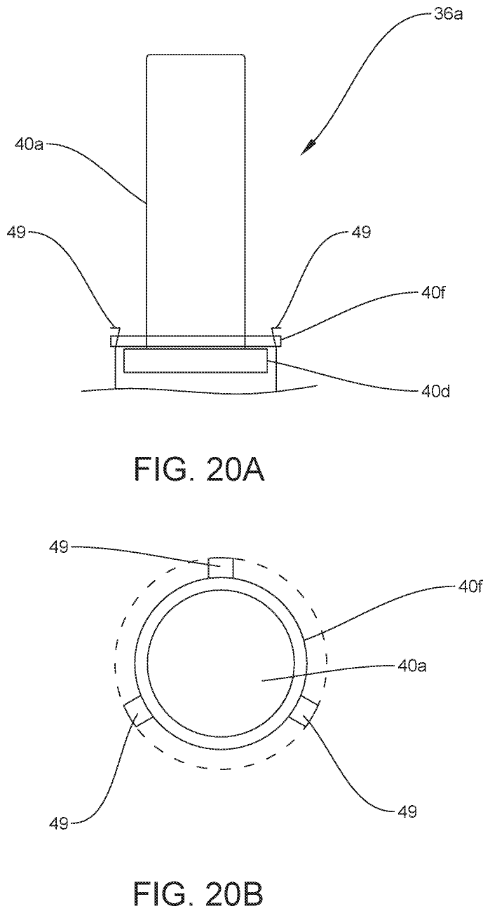

The following discussion includes a description of an aircraft/UAM vehicle recovery system, in accordance with the principles of the present disclosure. Alternate embodiments are also disclosed. Reference will now be made in detail to the exemplary embodiments of the present disclosure, which are illustrated in the accompanying figures. Turning to FIGS. 1-27B, there is illustrated components of a vehicle recovery system 10.

The components of vehicle recovery system 10 can be fabricated from materials including metals, polymers and/or composites, depending on the particular application. For example, the components of vehicle recovery system 10, individually or collectively, can be fabricated from materials such as aluminum, steel, iron, stainless steel, titanium, titanium alloys, cobalt-chrome, stainless steel alloys, semi-rigid and rigid materials, plastics, elastomers, Kevlar, nylon, polyester, carbon fiber, rubbers and/or rigid polymers. Various components of vehicle recovery system 10 may have material composites, including the above materials, to achieve various desired characteristics such as strength, rigidity, elasticity, performance and durability. The components of vehicle recovery system 10, individually or collectively, may also be fabricated from a heterogeneous material such as a combination of two or more of the above-described materials. The components of vehicle recovery system 10 can be extruded, molded, injection molded, cast, pressed, sewn and/or machined. The components of vehicle recovery system 10 may be monolithically formed, integrally connected or include fastening elements and/or instruments, as described herein.

In some embodiments, vehicle recovery system 10 is configured to enable the safe touchdown condition of an aircraft/UAM vehicle in case of an in-flight emergency. In some embodiments, vehicle recovery system 10 includes a vehicle-capture whole aircraft/UAM vehicle parachute and retro-rocket deceleration system into one or more aircraft/UAM vehicle. Vehicle recovery system 10 is adapted to overcome the challenges accompanying zero forward speed and the associated issues with elevations from approximately 15-feet Above Ground Level (AGL) until a point where a recovery parachute has height, time to deploy, inflate and slow the vehicle decent to a touchdown condition goal (approximately <30-feet per second). Vehicle recovery system 10 combines technologies of a whole vehicle recovery parachute system and a retro-rocket to slow decent. This provides several advantages that assure superior performance over the performance envelope. The installation of vehicle recovery system 10 is simpler, lighter and requires less space than a traditional whole aircraft/UAM vehicle recovery system.

In some embodiments, vehicle recovery system 10 deploys a retro-rocket first in a sequence followed by three individual tractor rockets that extract three smaller parachute canopies. The tractor rockets can be aimed in any direction to allow for simultaneous multiple extractions of the three parachutes with selected trajectories to provide rapid inflation of the parachute canopies. In some embodiments, the retro-rocket deploys first and is attached via a bridle to an aircraft/UAM vehicle harness attachment point to slow the decent of the aircraft/UAM vehicle. The retro-rocket separates utilizing break cord specifically tuned to the individual aircraft/vehicle characteristics after full line stretch and almost simultaneously individual tractor rockets will extract the three parachute canopies. The extraction of the canopies takes place the very instant the retro-rocket leaves the aircraft/UAM vehicle. The individual parachute tractor rockets will pull a bridle attached to the harness where the suspension lines are attached to the bridle. This provides a superior performance by inflating the canopy during the extraction sequence via the tractor rocket, thus addressing zero forward speed system performance not dependent on altitude loss to inflate the canopy. As the 32-foot per second, per second acceleration rate of the free falling aircraft/vehicle has been retarded by the retro-rocket, the canopies are not dependent on vertical or downward velocity to fill the canopy, which significantly reduces the inflation time and minimizes altitude loss during deployment.

Vehicle recovery system 10 is configured to perform in a manner that is predictable, stable and free of any variances that would interfere with retro-rocket or parachute deployment. Since, the rapid opening of the parachutes is a necessity for low forward speed or low altitude deployment, the trajectory height is the minimum required to open the recovery parachutes. The tractor rockets extracting the three parachutes are at trajectories that create divergent paths for simultaneous extraction without risk of parachute damage from rocket blast and are protected by a heat resistant sleeve. In some embodiments, vehicle recovery system 10 employs a two-phase sequence such that the parachute can be opened instantly at low speed (up to the structural limitation of the parachute) without the use of highly technical and heavy line-spreader devices.

In some embodiments, vehicle recovery system 10 attaches a retro-rocket capable of producing sufficient thrust to slow the decent of the aircraft/UAM vehicle. Each parachute is attached to a smaller tractor rocket that will begin extracting the parachutes once the retro-rocket has cleared the aircraft/UAM vehicle structure. The retro-rocket and the three parachutes are attached to a bridle that is attached to the aircraft/UAM vehicle harness. The harness is attached at three or four aircraft/UAM vehicle attachment points sufficient to withstand the loading produced. In some embodiments, the location of center of gravity dictates the design of the aircraft/UAM vehicle attachment harness. The tractor rockets are aimed at 120-degrees separation around the centerline bridle. They disconnect after full line stretch and sleeve removal to ensure that they will not entangle with the parachutes or provide hazards on the ground that could impede egress of occupants or be a source of heat.

In some embodiments, the retro-rocket slows the vehicle decent during the first one-half second of the deployment sequence. The activation of the tractor rockets immediately thereafter permits parachute inflation with phenomenal rapidity when the aircraft/UAM vehicle is in the low forward speed environment. To cover the spectrum from zero-zero to 175 knots, the parachute has the strength to withstand the tractor rocket deployment as well as conditions of forward velocity of the vehicle should the deployment occur during cruise flight.

In some embodiments, vehicle recovery system 10 is configured to be a complete assembly manufactured to the highest standards using the best military specifications and materials available today. In some embodiments, the canopies are manufactured in Dunlap, Tennessee by Precision Aerodynamics, which is FAA certified for design and production of parachute equipment. In some embodiments, vehicle recovery system 10 uses a solid propellant retro-rocket to slow the vertical decent of the vehicle in combination with three individual tractor rocket motors to extract three round, non-steerable parachutes in catastrophic emergency situations consisting of one or a plurality of retro-rockets, one or a plurality of parachutes, one or a plurality of deployment bags, one or a plurality of rocket motor/activation systems, one or a plurality of rocket lanyards and bridles, one or a plurality of aircraft/UAM vehicle attachment harnesses and hardware, one or a plurality of parachute boxes and covers, one or a plurality of electronic activation systems, and one or a plurality of sensors.

In some embodiments, the retro-rocket is attached to the aircraft/UAM vehicle with a bridle and is independent of weight distribution or shape of the item below it. The nozzles thrust vectors are angled outward from the rocket axis to prevent flame or objects from impinging on the parachute or the bridle in combination with a heat resistive protective sleeve. In some embodiments, the retro-rocket is provided with redundant dual ignition (dual bridge wire, dual initiators, etc.) so that ignition is always prompt and positive. The snatch load at line stretch is projected to be below 9 Gs deceleration. The swivel-mounted bride has 55% elongation at breaking strength. In some embodiments, the retro-rocket is mounted in a variety of ways depending on aircraft/UAM vehicle design.

In some embodiments, the parachute is configured for large certified aircraft/UAM vehicle exceeding 6,000 lbs. Maximum Takeoff Weight (MTOW). In some embodiments, the parachute uses a polyconical design with an extended skirt to maximize the drag coefficient. In some embodiments, the parachute is packed into a container, which is attached to the airframe. The parachute canopy is in a bag-pack configuration to avoid line interference and entanglement during deployment. In some embodiments, the parachute includes suspension lines, running from the canopy to the riser. The suspension lines have a high-strength, but lightweight, line material, which gives a much better strength to weight ratio while reducing the pack volume. In some embodiments, the suspension lines are attached to thick Kevlar straps as risers.

In some embodiments, the parachute assemblies are pressure packed or vacuum packed to preserve volume. To preserve this high-density pack volume, the parachutes are also baked to reduce moisture content, maintain compaction and extend packed life. The deployment bag is used to contain each pressure-packed parachute assembly and stage its deployment and inflation sequence when the system is activated. The deployment bag creates an orderly deployment process by allowing the canopy to inflate only after the extraction device has pulled the parachute attachment harness, riser and suspension lines taut, and pulled the deployment bag off the canopy. This prevents slack or uneven tension in the suspension lines during canopy inflation that could result in a malfunction.

In some embodiments, the rocket motor/activation system includes an activation subsystem and an extraction subsystem. The rocket motor is the primary device for extracting the parachutes away from the aircraft/UAM vehicle in the shortest possible amount of time to provide maximum recovery performance. The deployment system rocket motors are all maintenance free, requiring only a visual inspection in conjunction with the vehicle annual scheduled maintenance and then replacement at the end of their respective installed lives. In some embodiments, the rocket motor or gas generator propellant, thermal battery heat powder, etc., will have specific installed life limits. These devices and the selection of materials used will consider the longest possible installed lives. By selecting existing, proven materials, the maximum initial life can be applied. Each extraction device (retro-rocket and tractor rockets) will be electrically activated using the output of an electronically fired thermal battery. The electrical output of this device will be routed from the cockpit to the extraction device through a conventional insulated and shielded wiring harness. In some embodiments, all components of the extraction system will have a 1.3 or 1.4 hazard classification. In some embodiments, the rocket motor/activation system requires no scheduled maintenance. In some embodiments, the rocket motor/activation system has a long-installed life. In some embodiments, the rocket motor/activation system is safe to handle. In some embodiments, the rocket motor/activation system provides reliable life-saving capability.

In some embodiments, the rocket motor is attached to the deployment bag via a set of Teflon sheathed stainless steel cables, or rocket lanyards, and an energy attenuator in the bridle. The energy attenuator bridle, which is connected to the end of the rocket lanyards, is protected from the hot rocket exhaust by a heavy Kevlar bridle sheath.

In some embodiments, vehicle recovery system 10 uses a harness assembly fabricated from Kevlar webbing to attach the retro-rocket and each parachute to the vehicle's primary structure. Kevlar has 4 times the strength-to-weight ratio of steel and is much more flexible than steel cable, a distinct advantage for stowage. The harness system is typically attached to 3 or 4 points that surround the vehicle's center of gravity. These harness systems can also be designed to control the pitch dynamics of the aircraft/UAM vehicle during the deployment cycle by limiting the aft attachment harness length until the deployment cycle is complete.

In some embodiments, the pressure-packed parachute, rocket motor, and rocket motor lanyards and bridles are stowed inside a parachute box to protect them from the elements. The activation cable and vehicle attachment harnesses are routed from the parachute box to their respective mounting locations. The parachute box requires a cover that will remain securely attached during normal operations yet will be easily removed by the tractor rocket during system activation. A variety of box and cover materials can be utilized depending on the airframe structure and mounting constraints.

In some embodiments, vehicle recovery system 10 has an electronic activation system that is designed to work with an input signal from either a manual operation deployment (generally a two-step switch configuration) or through the avionics systems on board the aircraft/UAM vehicle. The system meets the environmental testing requirements including shock, vibration, temperature and humidity, as well as Hazards Electromagnetic Radiation to Ordnance (HERO), Electro Magnetic Interference (EMI). An arm-fire configuration requires two steps to pull the handle, addressing the safety requirements of the system. Vehicle recovery system 10 operates independently of the aircraft/UAM vehicle power, to eliminate risks associated with a power loss on the aircraft/UAM vehicle. The thermal battery-operated system is the most reliable system available and is designed as per current military escape systems. In some embodiments, vehicle recovery system 10 has a laser-based system to determine the height above ground on deployment, decent rate and other data associated with a deployment.

In some embodiments, vehicle recovery system 10 provides an active parachute inflation or deceleration means to address the specific needs of the VTOL/eVTOL industry where vehicles operate at zero airspeed and low altitudes. In some embodiments, vehicle recovery system 10 is configured to be installed on aircraft/UAM vehicle that are equipped with or capable of having a whole airframe recovery parachute system installed. In some embodiments, vehicle recovery system 10 is configured to get a fully opened parachute over the aircraft/UAM vehicle in the shortest time possible. The use of the proposed “two-stage” deployment in combination with a retro-rocket are aimed toward achieving this objective. In some embodiments, vehicle recovery system 10 is configured for recovery under zero forward speed conditions at altitudes around 100 feet. The chart in FIG. 1 displays how well the goal can be accomplished using a large parachute only and comparison configurations of (#1) a 56-pound retro-rocket with 55-pounds of parachutes; (#2) a 111-pound retro-rocket and 40-pounds of parachutes; and, (#3) a 224-pound retro-rocket and a 14-pound parachute. Performance shown in the charts is based upon time beginning at the activation of recovery system (electronic signal provided by either the on-board flight computer or a manual activation of a two-stage deployment switch). By first providing a retro-rocket that can be deployed much faster than a parachute extraction and inflation, vehicle recovery system 10 immediately slows the decent. After this very rapid action, the tractor rockets extract the parachute pack and assist in very rapid inflation of the canopy. By reducing the inflation time, altitude loss is minimized, especially when combined with the slowdown in decent provided by the retro-rocket.

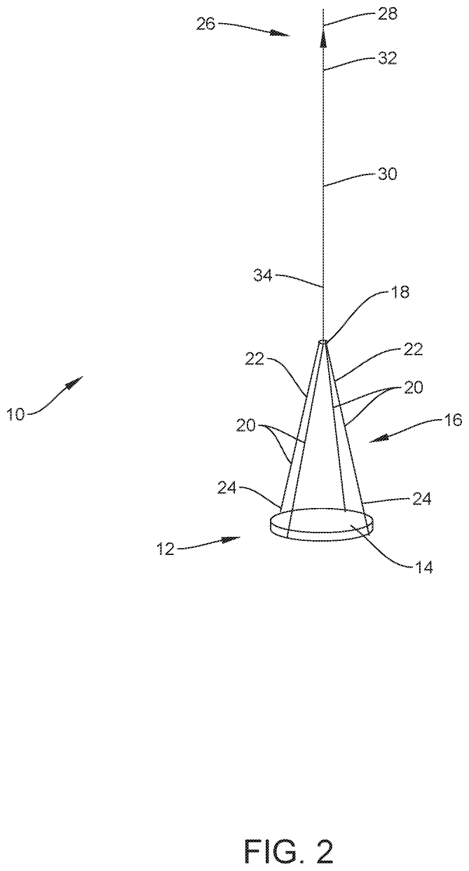

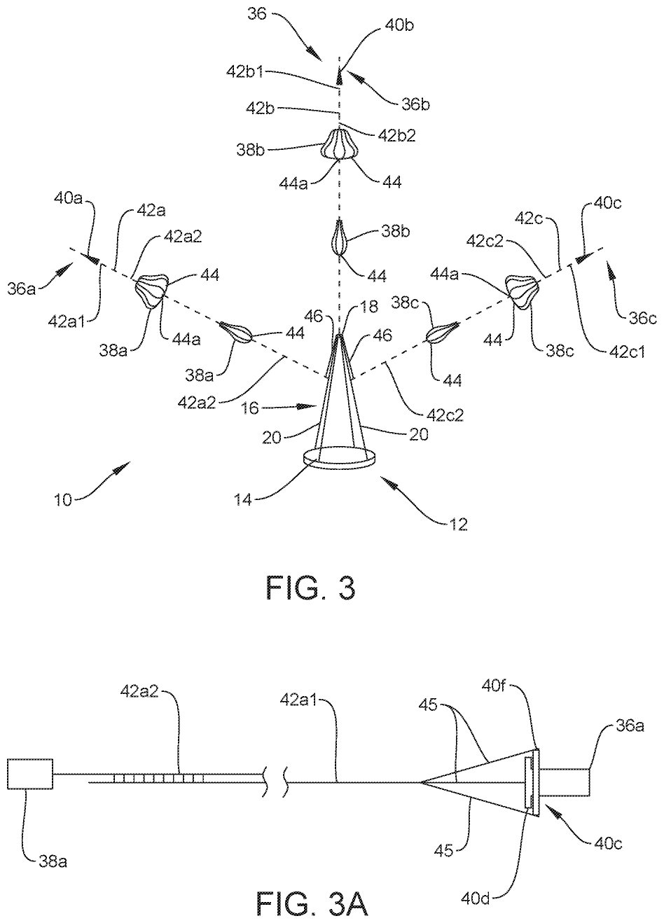

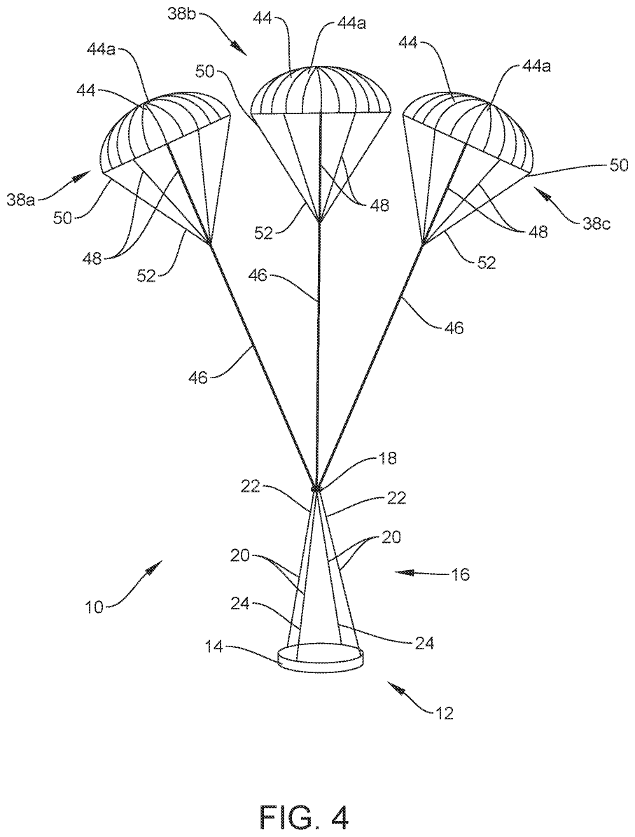

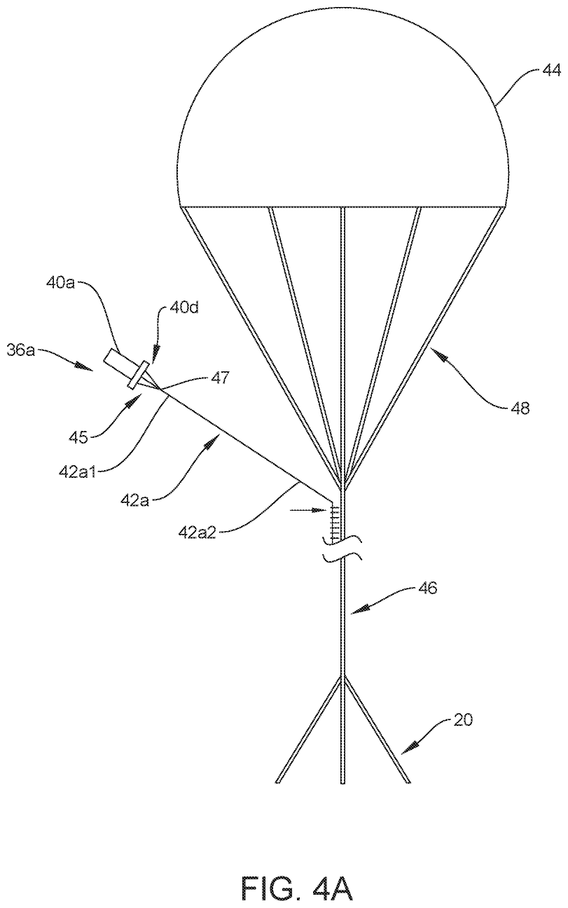

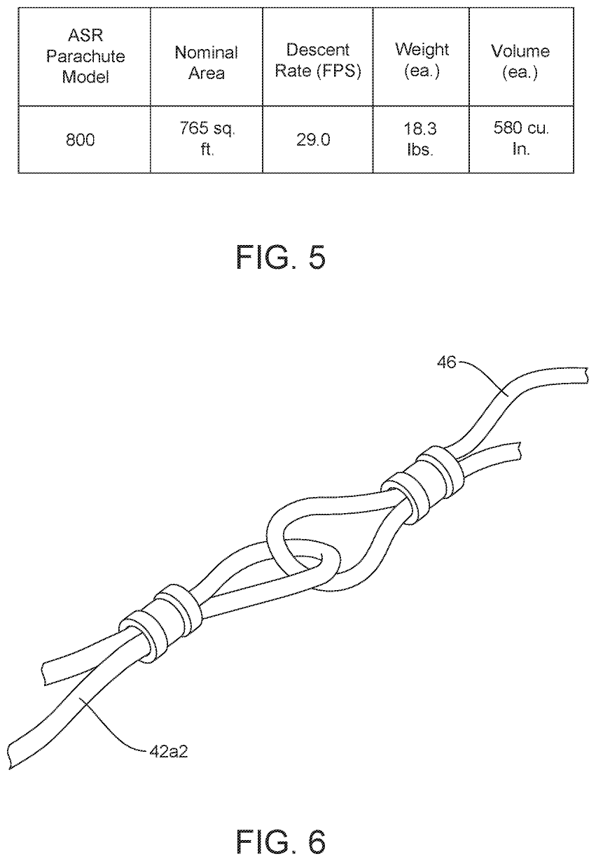

In some embodiments, vehicle recovery system 10 is designed and tested for aircraft/UAM vehicle weights up to 6,000 lbs. When the retro-rocket fires, it burns for approximately 0.5 seconds and produces enough thrust to rapidly slow the decent rate of the aircraft/UAM vehicle, as shown in FIG. 2. As soon as the retro-rocket clears the aircraft/UAM vehicle, the tractor rockets fire to extract the parachutes, as shown in FIG. 3. In some embodiments, it takes less than 150 milliseconds to reach line stretch. Since the tractor rockets are attached to the bottom of the parachutes, versus connection at the apex, the parachutes inflate very rapidly not dependent on altitude loss to inflate the canopy. The parachutes are attached to an incremental bridle that is sewn to the primary bridle that was extracted with the retro-rocket. With break thread, the stitches rip away under the force of the deployment. This avoids line entanglement. The canopies move from an upside down orientation, shown in FIG. 3, to an upright, shown in FIG. 4 to slow the aircraft/UAM vehicle decent rate further. In some embodiments, the aircraft/UAM vehicle decent rate is less than or equal to 30 feet per second vertical impact velocity (touchdown condition), as shown in FIG. 5.

There are some conditions where the vehicle could be dragged, post-impact along the ground. To avoid this and eliminate any further mechanism for injury, vehicle recovery system 10 has a release system that will automatically release the canopy once on the ground. In some embodiments, the release system interface with the previously proposed laser system to assure the vehicle is on the ground prior to canopy release.

In some embodiments, there are two stages or phases of the deployment sequence that occur nearly simultaneously. Lateral separation is obtained by aiming the rockets. The retro-rocket is deployed vertically and the three tractor rockets will be positioned at 120-degrees around the axis and deployed horizontally. This permits the nearly simultaneous deployment without the complexities and delays associated with a sequencing system. This technique reduces the time required for an extraction, separation, and canopy inflation. As the burn time for the retro-rocket is only about one-half second, the time required to begin parachute inflation will be within approximately one-third of a second from the activation.

In some embodiments, the initial activation of vehicle recovery system 10 can be from either (1) an on-board flight computer that sends a unique and coded signal to vehicle recovery system 10 to deploy, or, (2) a manual activation of a two-stage deployment switch by an occupant of the vehicle/aircraft/UAM vehicle. In either case, the activation will be electronic activation system that meets the environmental testing requirements including shock, vibration, temperature and humidity, as well and Hazards Electromagnetic Radiation to Ordnance (HERO), Electro Magnetic Interference (EMI). Vehicle recovery system 10 operates independently of the aircraft/UAM vehicle power, to eliminate risks associated with a power loss on the aircraft/UAM vehicle. In some embodiments, a thermal battery-operated system is used to activate and/or operate vehicle recovery system 10.

In one embodiment, vehicle recovery system 10 includes a vehicle, such as, for example, an aircraft/UAM vehicle 12 having a primary structure, such as, for example, a fuselage 14. A harness, such as, for example, a harness 16 is attached to fuselage 14. Harness 16 is configured to attach additional components of vehicle recovery system 10 to fuselage 14, as discussed herein. Harness 16 includes a harness attachment point, such as, for example, a hub 18 and a plurality of lines, such as, for example, cords 20. Cords 20 each include an end 22 and an opposite end 24. Ends 22 are coupled directly to hub 18 and ends 24 are coupled to fuselage 14 to connect fuselage 14 with harness 16. In some embodiments, ends 24 are attached to three or four points that surround the center of gravity of aircraft/UAM vehicle 12. In some embodiments, ends 22 are positioned circumferentially about hub 18. While FIGS. 2-4 show harness 16 including four cords 20, it is envisioned that harness 16 can include any number of cords 20. In some embodiments, all or part of harness 16 is fabricated from Kevlar webbing. In some embodiments, aircraft/UAM vehicle 12 has a weight that is less than or equal to 6,000 lbs. In some embodiments, aircraft/UAM vehicle 12 has a weight that is between 4,000 lbs. and 6,000 lbs. In some embodiments, aircraft/UAM vehicle 12 has a weight that is greater than or equal to 6,000 lbs. In some embodiments, aircraft/UAM vehicle 12 is configured for vertical take-off and/or landing.

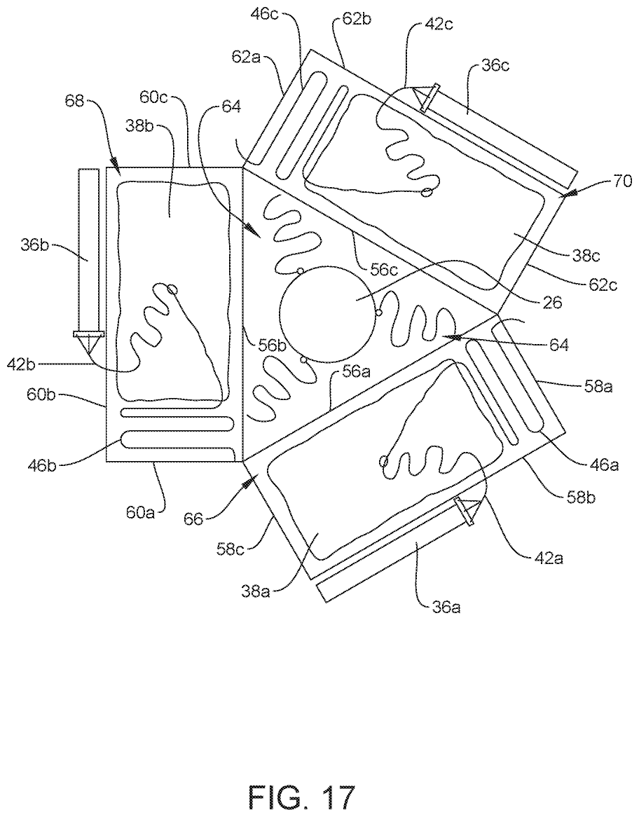

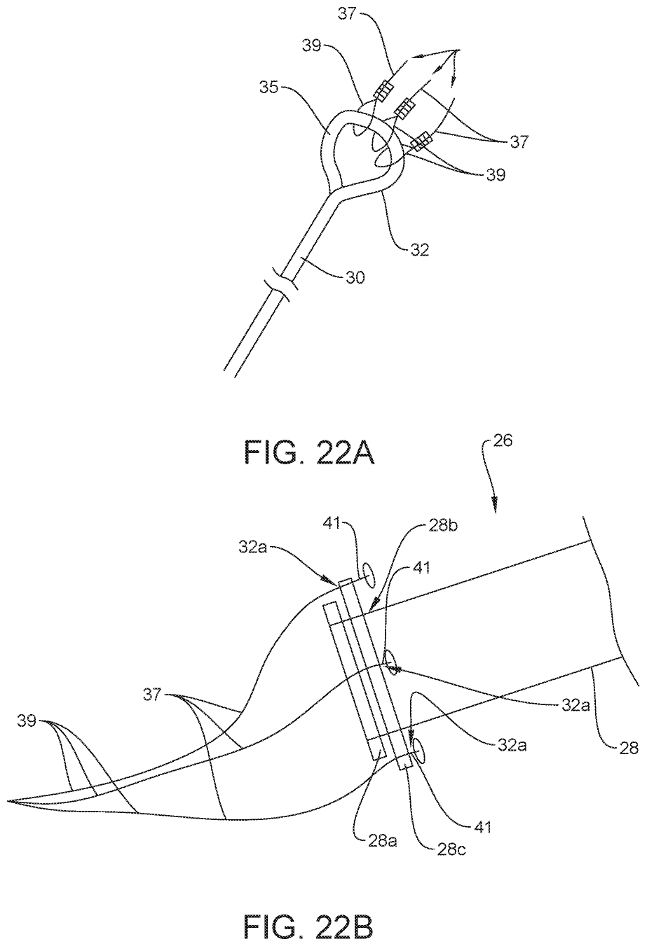

A retro-rocket 26 includes a body 28. A flange 28a extends outwardly from a distal end of body 28, as shown in FIG. 22B. Body 28 is positioned through an opening 28b of a pickup collar 28c. Pickup collar 28c is coupled to harness 16 by a cable, such as, for example, a bridle 30. In particular, bridle 30 includes an end 32 that is coupled to pickup collar 28c and an opposite end 34 that is coupled to hub 18. In some embodiments, end 32 extends through an opening 32a in pickup collar 28c. In one embodiment, shown in FIG. 22A, end 32 includes a loop 35. One or a plurality of cables, such as, for example, lanyards 37 each include an end 39 that is directly coupled to loop 35 and an opposite end 41 that extends through one of openings 32a to couple lanyards 37 to pickup collar 28c. Body 28 includes a rocket motor. In some embodiments, retro-rocket 26 is attached to hub 18 at a single attachment point, as shown in FIG. 2. Flange 28a has a maximum diameter that is greater than a maximum diameter of opening 28b such that pickup collar 28c will travel with retro-rocket 26 when retro-rocket 26 is deployed. That is, retro-rocket 26 will carry pickup collar 28c away from fuselage 14 when retro-rocket 26 is deployed. FIG. 16 shows retro-rocket 26 as retro-rocket 26 begins to extract harness 16, which is attached to retro-rocket 26 by bridle 30. As such, harness 16 is not visible in FIG. 16. As retro-rocket 26 moves away from aircraft/UAM vehicle 12, retro-rocket 26 will extract harness 16 from its storage location on aircraft/UAM vehicle 12.

Retro-rocket 26 is configured to be deployed in a first stage of a vehicle recovery protocol and produces sufficient thrust to slow the descent of aircraft/UAM vehicle 12, as discussed herein. In some embodiments, retro-rocket 26 is configured to burn for approximately 0.5 seconds after firing to produce enough thrust to slow the descent rate of aircraft/UAM vehicle 12. Retro-rocket 26 is configured to separate from harness 16 after a timed delay. That is, retro-rocket 26 separates from harness 16 when a timed line cutter severs a snubbed line releasing retro-rocket 26. In one embodiment, bridle 30 separates from hub 18 after a timed delay and retro-rocket 26 remains attached to bridle 30. In some embodiments, bridle 30 has a Kevlar sheath to protect bridle from hot exhaust from body 28. In some embodiments, bridle 30 is a Teflon sheathed stainless steel cable. In some embodiments, bridle 30 includes an energy attenuator. In some embodiments, retro-rocket 26 is not attached or in any way coupled to a parachute. That is, retro-rocket 26 is not used to extract a parachute. In some embodiments, retro-rocket 26 is a solid propellant retro-rocket.

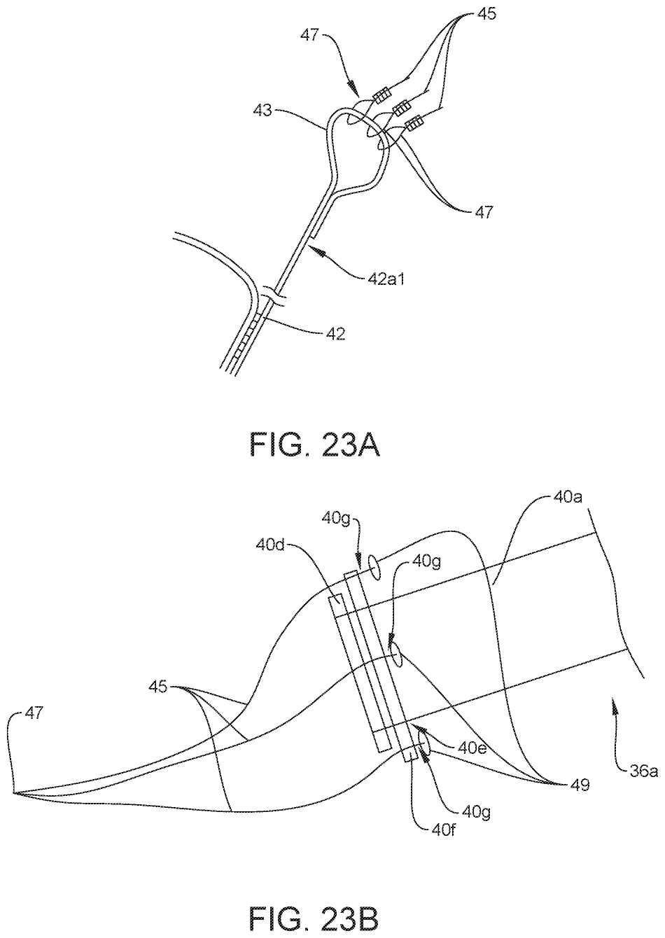

Vehicle recovery system 10 includes one or a plurality of additional rockets, such as, for example, tractor rockets 36. In one embodiment, vehicle recovery system 10 includes three tractor rockets 36a, 36b, 36c, as shown in FIG. 3. Tractor rocket 36a includes a body 40a. A flange 40d extends outwardly from a distal end of body 40a. Body 40a is positioned through an opening 40e of a pickup collar 40f. Pickup collar 40f is coupled to parachute 38a by a cable, such as, for example, a bridle 42a. Bridle 42a includes an end 42a1 that is coupled to pickup collar 40f and an opposite end 42a2 that is attached to parachute 38a. In some embodiments, end 42a1 is sewn directly to end 42a2 such that end 42a2 is separable from end 42a1. In some embodiments, end 42a1 extends through an opening 40g in pickup collar 40f. In some embodiments, end 42a1 extends through an opening 40g in pickup collar 40f to couple bride 42a to pickup collar 40f. In one embodiment, shown in FIGS. 23A and 23B, end 42a1 includes a loop 43. One or a plurality of cables, such as, for example, lanyards 45 each include an end 47 that is directly coupled to loop 43 and an opposite end 49 that extends through one of openings 40g to couple lanyards 45 to pickup collar 40f. Body 40a includes a rocket motor. Flange 40f has a maximum diameter that is greater than a maximum diameter of opening 40e such that pickup collar 40f will travel with tractor rocket 38a when tractor rocket 38a is deployed. That is, tractor rocket 38a will carry pickup collar 40f away from fuselage 14 when tractor rocket 38a is deployed. In some embodiments, bridle 42a becomes stretched as tractor rocket 38a extracts parachute 38a such that the stitching between end 42a2 and end 42a1 breaks to allow parachute 38a to inflate and rotate to vertical under the load of aircraft/UAM vehicle 12.

In some embodiments, tractor rocket 36b is the same or similar to tractor rocket 36a. Tractor rocket 36b includes a body 40b that is attached to a parachute 38b by a cable, such as, for example, a bridle 42b. Tractor rocket 36b includes a body 40b. A flange (not shown) extends outwardly from a distal end of body 40b. Body 40b is positioned through an opening of a pickup collar (not shown). The pickup collar is coupled to parachute 38b by a cable, such as, for example, a bridle 42b. Bridle 42b includes an end 42b1 that is coupled to the pickup collar and an opposite end 42b2 that is attached to parachute 38b. In some embodiments, end 42b1 extends through an opening in the pickup collar to couple bride 42b to the pickup collar. In one embodiment, end 42b1 includes a loop that is the same or similar to loop 43. One or a plurality of cables, such as, for example, lanyards that are the same or similar to lanyards 45 each include an end that is directly coupled to the loop and an opposite end that extends through one of the openings in the pickup collar to couple the lanyards to the pickup collar. Body 40b includes a rocket motor. The flange of body 40b has a maximum diameter that is greater than a maximum diameter of the opening in the pickup collar such that the pickup collar will travel with tractor rocket 38b when tractor rocket 38b is deployed. That is, tractor rocket 38b will the carry pickup collar away from fuselage 14 when tractor rocket 38b is deployed. In some embodiments, end 42b1 is sewn directly to end 42b2 such that end 42b2 is separable from end 42b1. In some embodiments, bridle 42b becomes stretched as tractor rocket 38b extracts parachute 38b such that the stitching between end 42b2 and end 42b1 breaks to allow parachute 38b to inflate and rotate to vertical under the load of aircraft/UAM vehicle 12.

In some embodiments, tractor rocket 36c is the same or similar to tractor rocket 36a and/or tractor rocket 36b. Tractor rocket 36c includes a body 40c that is attached to a parachute 38c by a cable, such as, for example, a bridle 42c. Tractor rocket 36c includes a body 40c. A flange (not shown) extends outwardly from a distal end of body 40b. Body 40b is positioned through an opening of a pickup collar (not shown). The pickup collar is coupled to parachute 38c by a cable, such as, for example, a bridle 42c. Bridle 42c includes an end 42c1 that is coupled to the pickup collar and an opposite end 42c2 that is attached to parachute 38c. In some embodiments, end 42c1 extends through an opening in the pickup collar to couple bride 42c to the pickup collar. In one embodiment, end 42c1 includes a loop that is the same or similar to loop 43. One or a plurality of cables, such as, for example, lanyards that are the same or similar to lanyards 45 each include an end that is directly coupled to the loop and an opposite end that extends through one of the openings in the pickup collar to couple the lanyards to the pickup collar. Body 40c includes a rocket motor. The flange of body 40c has a maximum diameter that is greater than a maximum diameter of the opening in the pickup collar such that the pickup collar will travel with tractor rocket 38c when tractor rocket 38c is deployed. That is, tractor rocket 38c will the carry pickup collar away from fuselage 14 when tractor rocket 38c is deployed. In some embodiments, end 42c1 is sewn directly to end 42c2 such that end 42c2 is separable from end 42c1. In some embodiments, bridle 4cb becomes stretched as tractor rocket 3cb extracts parachute 38c such that the stitching between end 42c2 and end 42c1 breaks to allow parachute 38c to inflate and rotate to vertical under the load of aircraft/UAM vehicle 12.

Tractor rockets 36a, 36b, 36c are configured to extract and rapidly inflate parachutes 38a, 38b, 38c in a second stage of a vehicle recovery protocol after retro-rocket 26 is deployed, as discussed herein. Tractor rockets 36a, 36b, 36c are the primary means for extracting parachutes 38a, 38b, 38c away from aircraft/UAM vehicle 12 in the shortest amount of time to provide maximum recovery performance.

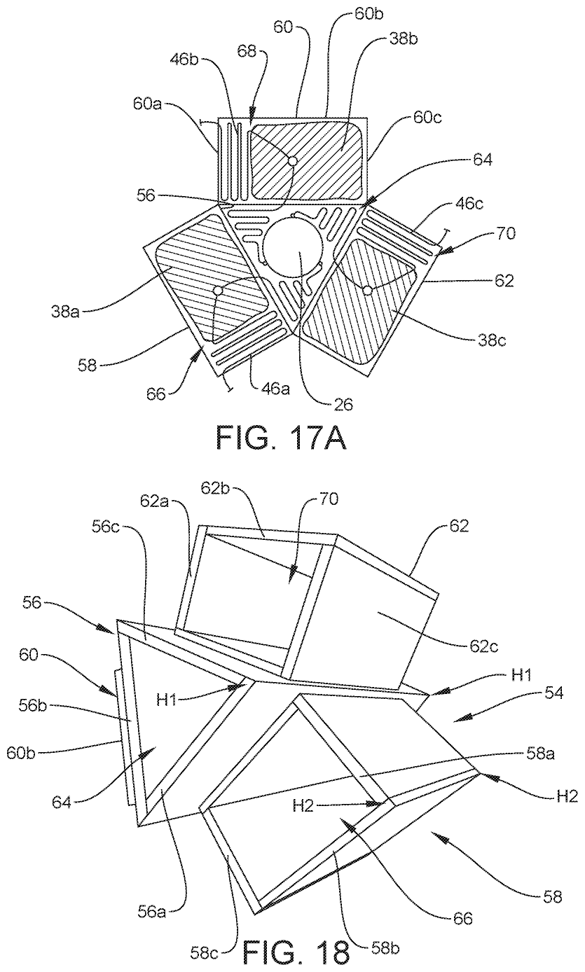

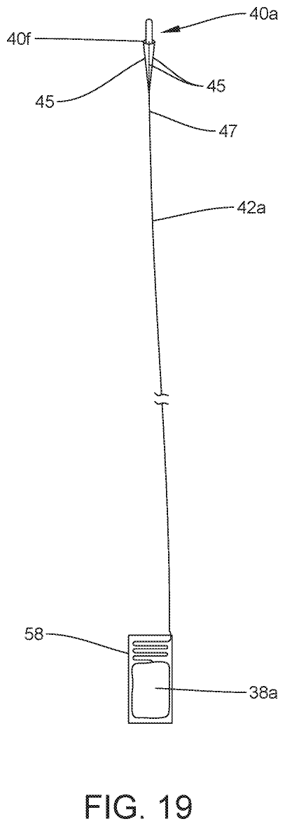

As discussed above, parachutes 38a, 38b, 38c are deployed by tractor rockets 36a, 36b, 36c. In one embodiment, shown in FIG. 17, system 10 parachutes 38a, 38b, 38c and retro-rocket 26 are stored in a housing 54 prior to deployment, as shown in FIG. 17. Tractor rockets 36a, 36b, 36c are positioned adjacent to housing 54. Housing 54 is coupled directly or indirectly to fuselage 14 and includes a central compartment 56 and compartments 58, 60, 62 positioned around compartment 56. Compartment 56 has a height H1 that is greater than heights H2 of compartments 58, 60, 62, as shown in FIG. 18. Compartment 56 includes walls 56a, 56b, 56c that are joined to form compartment 56. Inner surfaces of walls 56a, 56b, 56c define a cavity 64 configured for disposal of retro-rocket 26. Compartment 58 includes walls 58a, 58b, 58c that are joined with wall 56a to form compartment 58. Inner surfaces of walls 58a, 58b, 58c and an outer surface of wall 56a define a cavity 66 configured for disposal of parachute 38a. Compartment 60 includes walls 60a, 60b, 60c that are joined with wall 56b to form compartment 60. Inner surfaces of walls 60a, 60b, 60c and an outer surface of wall 56b define a cavity 68 configured for disposal of parachute 38b. Compartment 62 includes walls 62a, 62b, 62c that are joined with wall 56c to form compartment 62. Inner surfaces of walls 62a, 62b, 62c and an outer surface of wall 56c define a cavity 70 configured for disposal of parachute 38c. Deployment of tractor rockets 36a, 36b, 36c extracts bridles 42a, 42b, 42c from cavities 66, 68, 70, as shown in FIG. 19. As tractor rockets 36a, 36b, 36c move horizontally away from fuselage 14, tractor rockets 36a, 36b, 36c pull parachutes 38a, 38b, 38c out of cavities 66, 68, 70. In some embodiments, cavity, 64, cavity 66, cavity 68 and/or cavity 70 may have various cross section configurations, such as, for example, circular, oval, oblong, triangular, rectangular, square, polygonal, irregular, uniform, non-uniform, variable, tubular and/or tapered.

In one embodiment, shown in FIG. 17A, system 10 does not include tractor rockets 36a, 36b, 36c and parachutes 38a, 38b, 38c are configured to be deployed using retro-rocket 26 instead of tractor rockets 36a, 36b, 36c. In this embodiment, parachutes 38a, 38b, 38c and retro-rocket 26 are stored in a housing 54 prior to deployment, as shown in FIG. 17A.

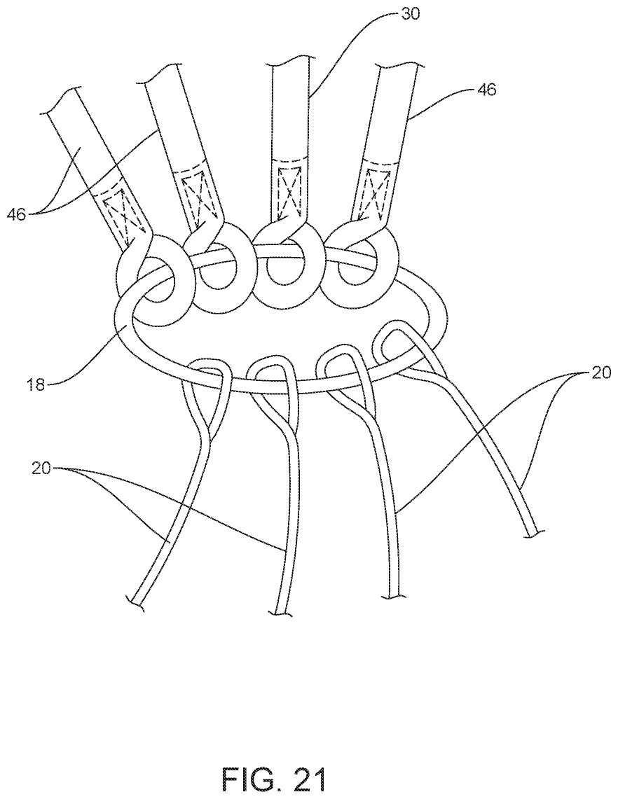

In some embodiments, parachutes 38a, 38b, 38c are each folded and packed disposed within a sleeve 72. In some embodiments, parachutes 38a, 38b, 38c are each covered by one of sleeves 72 when tractor rockets 36a, 36b, 36c are deployed. In some embodiments, suspension lines 48 are attached permanently to main riser 46 for each of parachutes 38a, 38b, 38c. Tractor rockets 36a, 36b, 36c are attached only by parallel stitching in line with riser 46, as shown in FIG. 8 so as to extract one of parachutes 38a, 38b, 38c and pull the respective one of parachutes 38a, 38b, 38c to full line stretch to inflate the canopy of the respective one of parachutes 38a, 38b, 38c. Once full line stretch is achieved and riser 46 is under load, a respective one of tractor rockets 36a, 36b, 36c and bridle 42 will tear off and fall away. Therefore, the bridle 42 is not directly attached to the suspension lines 48, but only to the riser 46. In some embodiments, hub 18 includes a loop 18a and risers 46 and bridle 30 are each coupled to loop 18a, as shown in FIG. 21.

In some embodiments, tractor rockets 36a, 36b, 36c can be aimed in any direction to allow parachutes 38a, 38b, 38c to be extracted with selected trajectories to provide rapid inflation of parachutes 38a, 38b, 38c. In some embodiments, tractor rockets 36a, 36b, 36c are oriented at trajectories that create divergent paths for simultaneous extraction, without risk of parachute damage from rocket blast. In some embodiments, tractor rockets 36a, 36b, 36c are aimed at 120-degree separation about an axis defined by hub 18. In some embodiments, tractor rockets 36a, 36b, 36c include a dual bridge wire or dual initiators to provide dual ignition so that ignition is always prompt and positive.

Parachutes 38a, 38b, 38c each include a canopy 44 that is coupled to a riser 46 by a plurality of suspension lines 48. Risers 46 are each coupled to an incremental bridle 45 that is attached to hub 18 to connect parachutes 38a, 38b, 38c to harness 16. Suspension lines 48 each include an end 50 coupled to canopy 44 and an opposite end 52 coupled to riser 46. Ends 52 of suspension lines 48 of parachute 36a are coupled to end 42a2 of bridle 42a and to main line 46 of parachute 36a; ends 52 of suspension lines 48 of parachute 36b are coupled to end 42b2 of bridle 42b and to riser 46 of parachute 36b; and ends 52 of suspension lines 48 of parachute 36c are coupled to end 42c2 of bridle 42c and to riser 46 of parachute 36c.

In some embodiments, parachutes 38a, 38b, 38c are round, non-steerable parachutes. In some embodiments, one or more of parachutes 38a, 38b, 38c has a polyconical design with an extended skirt to maximize the drag coefficient. In some embodiments, one or more of parachutes 38a, 38b, 38c is a gliding parachute, a parafoil, a ram air inflatable airfoil, sail-wing parachute, a volplane parachute, a single surface gliding parachute, a parawing, a circular parachute, conical parachute, biconical parachute, polyconical parachute, extended skirt parachute, hemispherical parachute, guide surface parachute, ringslot parachute, ringsail, rotafoil, Sandia RFD, disc-band-gap parachute, a cruciform parachute, a vortex ring parachute, a paracommander parachute, or a toju style slotted parachute.

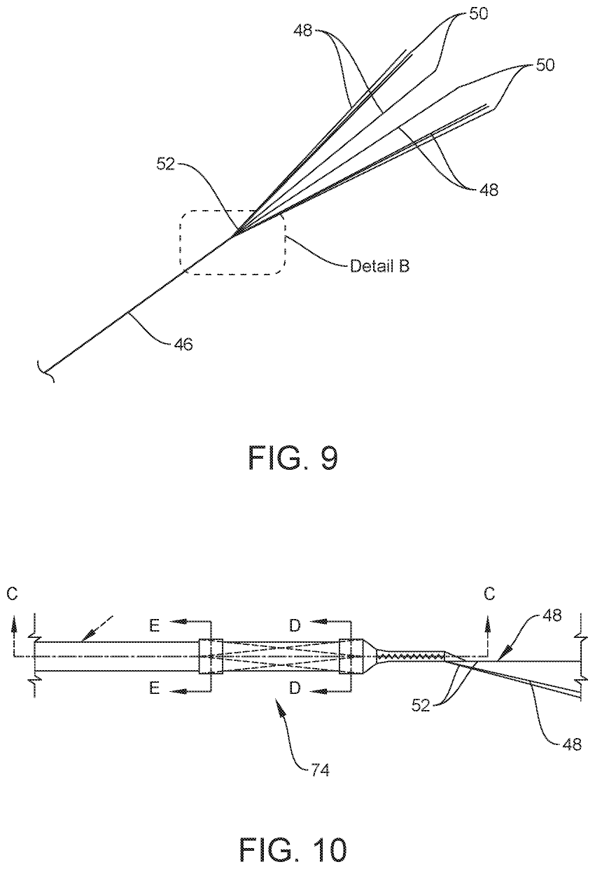

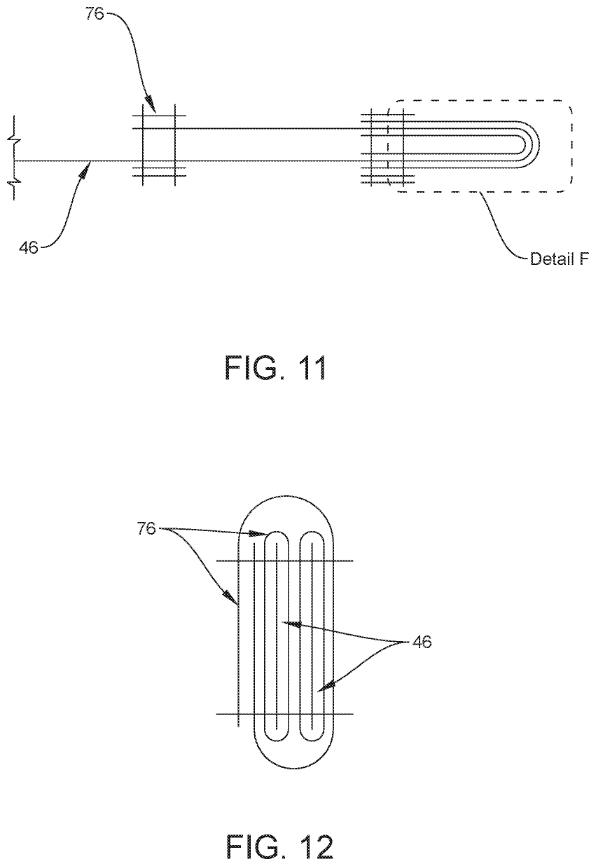

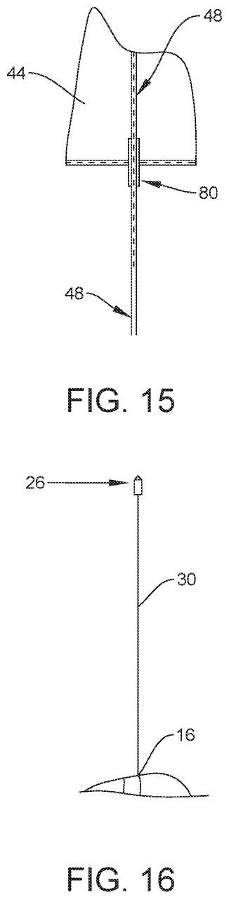

In some embodiments, ends 52 of suspension lines 48 are coupled to riser 46 via a connector 74, as shown in FIGS. 9-14. As shown in FIGS. 11-13, webbing, such as, for example, Kevlar webbing 76 couples riser 46 to connector 74. In some embodiments, sheaths, such as, for example, Teflon sheaths 78 are provided to reduce friction upon deployment and/or reduce heat build up. In some embodiments, suspension lines 48 are coupled to canopies 44 using reinforcement tape 80, as shown in FIG. 15.

In some embodiments, tractor rockets 36a, 36b, 36c are configured to deploy the very instant retro-rocket 26 leaves aircraft/UAM vehicle 12. In some embodiments, tractor rockets 36a, 36b, 36c are configured to deploy after retro-rocket 26 has cleared aircraft/UAM vehicle 12. In some embodiments, tractor rockets 36a, 36b, 36c are designed with a time/thrust curve to produce sufficient energy over a specified burn time to extract parachutes 38a, 38b, 38c. In some embodiments, tractor rockets 36a, 36b, 36c are configured to detach from parachutes 38a, 38b, 38c once tractor rockets 36a, 36b, 36c are a selected distance from parachutes 38a, 38b, 38c. In one embodiment, the selected distance is equal to the maximum length of bridles 42a, 42b, 42c. That is, once tractor rockets 36a, 36b, 36c are spaced apart from parachutes 38a, 38b, 38c by the maximum lengths of bridles 42a, 42b, 42c, bridles 42a, 42b, 42c break away from the risers 46a, 46b, 46c. In one embodiment, bridles 42a, 42b, 42c become fully stretched in less than 150 milliseconds after tractor rockets 36a, 36b, 36c are deployed. In one embodiment, tractor rockets 36a, 36b, 36c deployed horizontally relative to fuselage 14 and/or a surface that aircraft/UAM vehicle 12 is flying over such that tractor rockets 36a, 36b, 36c parallel to fuselage 14 and/or a surface that aircraft/UAM vehicle 12 is flying over.

As tractor rockets 36a, 36b, 36c are deployed, tractor rockets 36a, 36b, 36c pull parachutes 38a, 38b, 38c away from aircraft/UAM vehicle 12 such that canopies 44 have a concave orientation and apices 44a of canopies 44 face toward aircraft/UAM vehicle 12, as shown in FIG. 3. That is, suspension lines 48 of parachutes 38a, 38b, 38c are positioned between bodies 40a, 40b, 40c of tractor rockets 36a, 36b, 36c and canopies 44 of parachutes 38a, 38b, 38c. After, tractor rockets 36a, 36b, 36c detach from parachutes 38a, 38b, 38c, canopies 44 invert to have a convex orientation and apices 44a face away from aircraft/UAM vehicle 12 to rapidly inflate parachutes 38a, 38b, 38c, as shown in FIG. 4. That is, suspension lines 48 of parachutes 38a, 38b, 38c are positioned between canopies of parachutes 38a, 38b, 38c and riser 46. Since the descent rate of aircraft/UAM vehicle 12 has been slowed down by retro-rocket 26, canopies 44 of parachutes 38a, 38b, 38c are not dependent vertical or downward velocity to fill canopies 44, which significantly reduces the inflation time and minimizes altitude loss during deployment.

In some embodiments, retro-rocket 26 and tractor rockets 36a, 36b, 36c are electrically activated using the output of an electronically fired thermal battery. The electrical output can be routed from the cockpit of aircraft/UAM vehicle 12 to retro-rocket 26 and tractor rockets 36a, 36b, 36c through a conventional insulated and shielded wiring harness. In some embodiments, vehicle recovery system 10 has an electronic activation system that is designed to work with an input signal from either a manual operation deployment (e.g., a two-step switch configuration) or through an avionics system of aircraft/UAM vehicle 12. In some embodiments, vehicle recovery system 10 includes a thermal battery and operates independently of the power of aircraft/UAM vehicle 12, to eliminate risks associated with a power loss on aircraft/UAM vehicle 12.

In operation and use, vehicle recovery system 10 is activated during an in-flight emergency of aircraft/UAM vehicle 12 to perform a vehicle recovery protocol. In some embodiments, the in-flight emergency occurred with aircraft/UAM vehicle 12 flying at a low altitude (about 100 feet) with no forward speed. Retro-rocket 26 is deployed in a first stage of the vehicle recovery protocol such that body 28 moves vertically relative to the surface aircraft/UAM vehicle 12 is flying over to reduce the descent rate of aircraft/UAM vehicle 12. In some embodiments, body 28 moves along a path that is perpendicular to the surface aircraft/UAM vehicle 12. In a second stage of the vehicle recovery protocol, tractor rockets 36a, 36b, 36c are deployed. In some embodiments, tractor rockets 36a, 36b, 36c are deployed immediately after retro-rocket 26 is deployed. In some embodiments, tractor rockets 36a, 36b, 36c are deployed immediately after retro-rocket 26 clears aircraft/UAM vehicle 12. Tractor rockets 36a, 36b, 36c pull parachutes 38a, 38b, 38c away from aircraft/UAM vehicle 12 such that canopies 44 have a concave orientation and apices 44a of canopies 44 face toward aircraft/UAM vehicle 12, as shown in FIG. 3. After, tractor rockets 36a, 36b, 36c detach from parachutes 38a, 38b, 38c, canopies 44 rotate to have a convex orientation and apices 44a face away from aircraft/UAM vehicle 12 to rapidly inflate parachutes 38a, 38b, 38c to further reduce the descent rate of aircraft/UAM vehicle 12, as shown in FIG. 4.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A vehicle recovery system comprising:
a harness comprising a hub and a plurality of cords each including opposite first and second ends, the first ends each being coupled to the hub, the second ends each being configured to be connected to a fuselage of a vehicle;
a tractor rocket including a body and a bridle, the bridle including a first end coupled to the body and an opposite second end; and
a parachute including a riser, a canopy and a plurality of suspension lines, the suspension lines each including a first end coupled the canopy and an opposite second end coupled a first end of the riser, an opposite second end of the riser being coupled to the hub, the second end of the bridle being coupled to the first end of the riser.

2. The vehicle recovery system recited in claim 1, wherein the tractor rocket is configured to deploy the parachute such that the canopy moves from a concave orientation to a convex orientation as the parachute descends.

3. The vehicle recovery system recited in claim 1, wherein the parachute is non-steerable.

4. The vehicle recovery system recited in claim 1, wherein the canopy has a polyconical design with an extended skirt.

5. The vehicle recovery system recited in claim 1, wherein:
the tractor rocket includes a plurality of tractor rockets; and
the parachute includes a plurality of parachutes.

6. The vehicle recovery system recited in claim 1, wherein the second end of the bridle is configured to break away from the first end of the riser when the bridle is fully stretched by the tractor rocket.

7. The vehicle recovery system recited in claim 1, further comprising the vehicle.

8. A vehicle recovery system comprising:
a harness comprising a hub and a plurality of cords each including opposite first and second ends, the first ends each being coupled to the hub, the second ends each being configured to be connected to a fuselage of a vehicle;
a retro-rocket including a first body and a first bridle, the first bridle including a first end coupled to the first body and an opposite second end coupled to the hub;
a plurality of tractor rockets each including a second body and a second bridle, the second bridle including a first end coupled to the second body and an opposite second end; and
a plurality of parachutes each including a riser, a canopy and a plurality of suspension lines, the suspension lines each including a first end coupled the canopy and an opposite second end coupled to a first end of the riser, an opposite second end of the riser being coupled to the hub, the second end of the second bridle being coupled to the first end of the riser.

9. The vehicle recovery system recited in claim 8, wherein the retro-rocket is configured to be deployed before the tractor rockets are deployed.

10. The vehicle recovery system recited in claim 8, wherein the second end of the first bridle is configured to detach from the hub when the first body is a selected distance from the hub.

11. The vehicle recovery system recited in claim 10, wherein the selected distance is equal to a maximum length of the first bridle.

12. The vehicle recovery system recited in claim 8, wherein the plurality of tractor rockets comprises three tractor rockets each configured to deploy 120 degrees apart from an adjacent one of the three tractor rockets.

13. The vehicle recovery system recited in claim 8, wherein the tractor rockets are configured to deploy the parachutes such that the canopies each move from a concave orientation to a convex orientation as the parachutes descend.

14. The vehicle recovery system recited in claim 8, wherein the second ends of the bridles are configured to detach from the first ends of the risers when the second bodies are a selected distance from the hub.

15. A method for recovering a vehicle, the method comprising:
providing a vehicle having a fuselage equipped with a vehicle recovery system, the vehicle recovery system comprising:
a harness comprising a hub and a plurality of cords each including opposite first and second ends, the first ends each being coupled to the hub, the second ends each being configured to be connected to the fuselage,
a retro-rocket including a first body and a first bridle, the first bridle including a first end coupled to the first body and an opposite second end coupled to the hub,
a plurality of tractor rockets each including a second body and a second bridle, the second bridle including a first end coupled to the second body and an opposite second end, and
a plurality of parachutes each including a riser, a canopy and a plurality of suspension lines, the suspension lines each including a first end coupled the canopy and an opposite second end coupled to a first end of the riser, an opposite second end of the riser being coupled to the hub, the second end of the bridle being coupled to the first end of the riser;
deploying the retro-rocket to reduce a downward speed of the vehicle;
deploying the tractor rockets after the retro-rocket is deployed such that the canopies each move from a concave orientation to a convex orientation as the parachutes descend to further reduce the downward speed of the vehicle.

16. The method recited in claim 15, wherein the second end of the first bridle detaches from the hub when the first body is a selected distance from the hub.

17. The method recited in claim 16, wherein the tractor rockets are deployed simultaneously as the second end of the first bridle is detaches from the hub.

18. The method recited in claim 15, wherein the tractor rockets are deployed as the retro-rocket clears the vehicle.

19. The method recited in claim 15, wherein the second ends of the bridles detach from the first ends of the risers when the second bodies are a selected distance from the hub.

20. The method recited in claim 15, wherein the vehicle is an Urban Air Mobility configured for vertical take-off and landing.
